(19) United States
(12) Patent Application Publication
(10) Pub. No.: US 2022/0228552 A1
(43) Pub. Date: Jul. 21, 2022

(54) WIND TURBINE BLADE SPAR STRUCTURE

(71) Applicant: Vestas Wind Systems A/S, Aarhus N (DK)

(72) Inventor: Jonathan Smith, Burridge, Southampton (GB)

(21) Appl. No.: 17/609,149

(22) PCT Filed: May 5, 2020
(86) PCT No.: PCT/DK2020/050133

§ 371 Date: Nov. 5, 2021

(30) Foreign Application Priority Data
May 8, 2019 (DK) PA 2019 70294

(51) Int. Cl. F03D 1/06; B29C 65/48

(52) U.S. Cl. CPC F03D 1/0675; B29L 2031/085; B29C 65/48

(57) ABSTRACT

In a first aspect of the invention there is provided a wind turbine blade shear web comprising an elongate web panel and a mounting flange extending along a longitudinal edge of the panel. The mounting flange comprises a base for bonding the shear web to a surface of a wind turbine blade shell and an upstand extending transversely to the base. The upstand is adhesively bonded to a side surface of the web panel and inclined relative to the side surface such that a bond gap is defined between the upstand and the side surface. The bond gap is at least partially filled with adhesive and one or more spacers are located in the bond gap, wherein the one or more spacers are configured to set an angle of inclination between the panel and the base of the mounting flange.

### TECHNICAL FIELD

The present invention relates generally to wind turbine blades and more specifically to an improved shear web for a wind turbine blade and method for assembling the same.

### BACKGROUND

Modern wind turbine blades comprise a longitudinally extending spar to increase the structural rigidity of the blade. In some wind turbine blades, the spar structure comprises a shear web attached between opposed spar caps. The shear web may be substantially I-shaped, comprising a web panel arranged between flanges that extend along longitudinal edges of the panel. The flanges may be manufactured off-line and integrated with the web panel during manufacture of the shear web, for example in a lamination process. Typically, the flanges comprise a base and an upstand extending away from the base. The flanges are attached to the spar caps in an assembled spar.

Optimally designed wind turbine blades typically twist along their spanwise length, between a root and a tip of the blade, to capture energy from the incident wind more effectively. The shear webs must be designed to accommodate blade twist. Known solutions involve varying the angle of the flange base with respect to the flange upstand along the length of the shear web, or alternatively maintaining a constant base-upstand angle and using additional adhesive in certain regions to fill the resultant gaps in bondlines between the flanges and the spar caps. In the former case, a number of different flange profiles must be manufactured to accommodate twist along the blade. In the latter case, blade weight is increased due to the use of additional adhesive, and variations in the bondline thickness can result in unfavourable structural characteristics for the spar.

It is against this background that the present invention has been developed.

### SUMMARY OF THE INVENTION

In a first aspect of the invention there is provided a wind turbine blade shear web comprising an elongate web panel and a mounting flange extending along a longitudinal edge of the panel. The mounting flange comprises a base for bonding the shear web to a surface of a wind turbine blade shell and an upstand extending transversely to the base. The upstand is adhesively bonded to a side surface of the web panel and inclined relative to the side surface such that a bond gap is defined between the upstand and the side surface. The bond gap is at least partially filled with adhesive and one or more spacers are located in the bond gap, wherein the one or more spacers are configured to set an angle of inclination between the panel and the base of the mounting flange.

The bond gap may be substantially triangular when viewed in transverse cross section. The one or more spacers may be substantially triangular in transverse cross section. The one or more spacers may be shaped as wedges.

The base of the mounting flange may be substantially parallel to the surface of the blade shell.

The mounting flange may comprise first and second spanwise flange sections bonded respectively to first and second spanwise sections of the panel, the first and second flange sections being substantially identical in transverse cross section. The base of the first flange section may be inclined at a first angle to the panel and the base of the second flange section may be inclined at a second angle to the panel, the second angle being different to the first angle. A first spacer may be arranged in the bond gap between the first flange section and the panel, and a second spacer may be arranged in the bond gap between the second flange section and the panel. The first spacer may have a different size and/or shape to the second spacer.

The angle of inclination between the panel and the base of the mounting flange may vary in a spanwise portion of the shear web, and an angle between the base and the upstand of the mounting flange may be substantially constant throughout the spanwise portion. This may be achieved as described above, wherein a portion of the shear web comprises a plurality of flange sections having a substantially identical transverse cross section, with the bases of the flange sections being inclined at different angles to the panel. Alternatively, a single spanwise flange section may define a plurality of angles between the panel and the base of the spanwise flange section in the spanwise portion of the shear web.

The shear web may comprise a mounting flange having a suitable torsional flexibility such that a single flange section may twist along its spanwise length, defining a plurality of angles between the shear web panel and the base of the mounting flange section along the length of said section. A plurality of spacers having different sizes and/or shapes may be located in the bond gap between the upstand of such a flange section and a side of the shear web panel.

The angle of inclination between the panel and the base of the mounting flange may vary along the length of the shear web, and an angle between the base and the upstand of the mounting flange may be substantially constant along the length of the shear web.

In a spanwise portion of the blade, the shear web may comprise a plurality of mounting flange sections wherein the angle between the base and the upstand of each flange section is different, the flange sections being dissimilar in transverse cross section. The angle between the base and upstand of a first flange section may therefore be different to the angle between the base and upstand of a second flange section in some spanwise portions of the blade.

The mounting flange may be substantially L-shaped in transverse cross section.

The shear web may comprise a further mounting flange extending along the longitudinal edge of the panel, said further mounting flange comprising a base and an upstand extending transversely to said base, said upstand being adhesively bonded to an opposite side surface of the web panel and inclined relative to the opposite side surface such that a further bond gap is defined between said upstand and the opposite side surface. The further bond gap may be at least partially filled with adhesive and one or more spacers may be located in the further bond gap.

The respective bases of the two mounting flanges may be substantially coplanar when the shear web is viewed in transverse cross section.

The mounting flange may comprise a further upstand extending transversely to the base, and the longitudinal edge of the panel may be received between the upstands such that a further bond gap is defined between the further upstand and an opposite side surface of the shear web panel. The further bond gap may be at least partially filled with adhesive and one or more spacers may be located in the further bond gap. The mounting flange may be substantially pi-shaped (π) in transverse cross section.

Both bond gaps may taper in width and one of the bond gaps may taper in an opposite sense to the other bond gap when the shear web is viewed in transverse cross section.

In another aspect of the present invention there is provided a wind turbine blade comprising the shear web as described herein. The blade shell may have a twisted profile and the angle of inclination between the panel and the base of the mounting flange may vary along the length of the shear web to accommodate the twisted profile of the blade shell.

The wind turbine blade may comprise an adhesive bondline between the base of the mounting flange and the surface of the blade shell. The height of the bondline from the blade shell surface to the mounting flange base may be substantially uniform along the length of the shear web as a result of the varying angle of inclination between the panel and the base of the mounting flange which sets the angle of inclination between the mounting flange base and the shear web panel to substantially match the twisted profile of the blade shell.

In a further aspect of the present invention there is provided a method of making a wind turbine blade shear web. The method comprises providing an elongate web panel, providing a mounting flange having a base and an upstand extending transversely to the base, and providing one or more spacers. The method further comprises setting an angle of inclination between the panel and the base of the mounting flange by arranging the one or more spacers between the upstand and a side surface of the panel and bonding the upstand to the side surface of the panel.

The method may further comprise curing adhesive between the upstand and the side surface.

The method may further comprise arranging a second mounting flange with a longitudinal edge of the shear web panel, the second mounting flange being arranged with its upstand inclined relative to a second side surface of the shear web panel. The method may further comprise applying adhesive between the upstand and second side surface and arranging one or more spacers between the upstand and second side surface of the panel to support the upstand of the additional mounting flange in inclined relation to the second side surface of the web panel.

The method may further comprise forming a compression joint clamping the upstand of a mounting flange to the shear web panel.

The method may further comprise arranging a mounting flange having a further upstand extending transversely to the base. Arranging the mounting flange with a longitudinal edge of the panel may comprise arranging the shear web panel between the upstands. The method may further comprise arranging one or more spacers between each of the upstands and the shear web panel to set an angle of inclination between the panel and the base of the mounting flange.

The method may further comprise supporting the shear web in a vertical orientation and applying a compressive force in a direction substantially parallel to the shear web panel, wherein the arrangement of the spacers serves to self-locate the mounting flange at the correct orientation with respect to the shear web panel.

### BRIEF DESCRIPTION OF THE DRAWINGS

The present invention will now be described in further detail by way of nonlimiting examples only with reference to the following figures in which:

FIG. 1a is a schematic perspective view of part of a wind turbine blade comprising a shear web in accordance with the prior art;

FIG. 1b is a detailed view of the region marked i in FIG. 1a;

FIG. 1c is a detailed view of the region marked ii in FIG. 1a;

FIG. 2a is a schematic perspective view of part of a further wind turbine blade comprising a shear web in accordance with the prior art;

FIG. 2b is a detailed view of the region marked iii in FIG. 2a;

FIG. 2c is a detailed view of the region marked iv in FIG. 2a;

FIG. 3 is a schematic view of an example of a shear web in a transverse cross section;

FIG. 4 is a schematic view of the shear web of FIG. 3 shown in a further transverse cross section;

FIG. 5 is a schematic view of part of a shear web arrangement in accordance with a further example in a transverse cross section;

FIG. 6 is a schematic view of a stage in the manufacture of a shear web shown in a transverse cross section;

FIG. 7a is a schematic perspective view of a portion of a wind turbine blade comprising an example of a shear web;

FIG. 7b is a detailed view of the region marked v in FIG. 7a;

FIG. 7c is a detailed view of the region marked vi in FIG. 7a;

FIG. 8 is a schematic view of a further portion of a shear web in a transverse cross section;

FIG. 9 is a schematic view of part of a shear web arrangement in accordance with a further example in a transverse cross section; and

FIG. 10 is a schematic view of a stage in the manufacture of the shear web arrangement of FIG. 9 in a transverse cross section.

### DETAILED DESCRIPTION

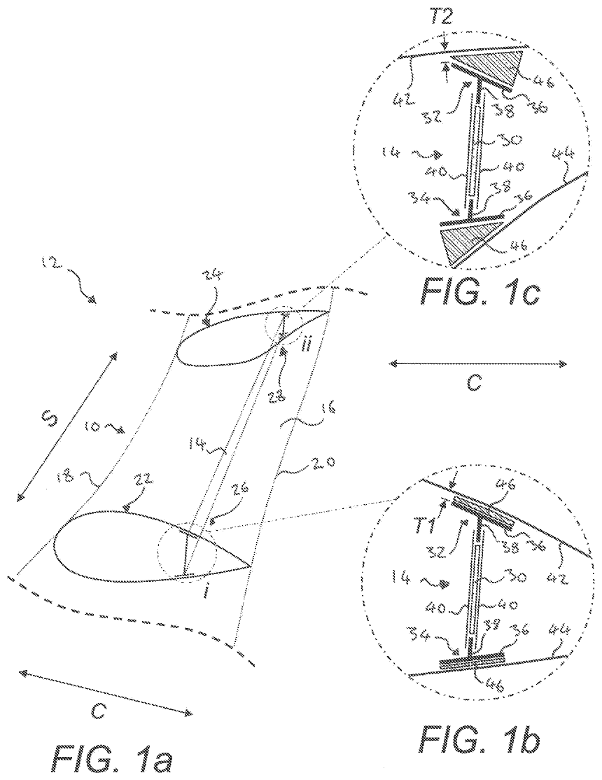

FIG. 1a is a schematic perspective view of a spanwise portion 10 of a wind turbine blade 12 comprising a shear web 14 according to the prior art. The wind turbine blade 12 comprises a shell 16 which extends in a spanwise direction (S), and in a chordwise direction (C) between a leading edge 18 and a trailing edge 20. The shear web 14 extends in the spanwise direction (S) to provide structural reinforcement to the blade 12. In the spanwise portion 10 shown, the blade shell 16 comprises an airfoil profile when viewed in a transverse cross section. Transverse cross sections 22, 24 in first and second spanwise sections 26, 28 of the shear web 14 are shown in FIG. 1a. As described by way of background, the blade 12 twists along its spanwise (S) length in order to maximise the capture of energy from wind incident on the blade 12. The twist of the blade 12 can be seen in a comparison of the cross sections 22, 24 in the first and second spanwise sections 26, 28 respectively, wherein the airfoil profiles are rotated in relation to one another.

FIGS. 1b and 1c respectively show enlarged views of the regions annotated i and ii in FIG. 1a. As shown in FIGS. 1b and 1c, the prior art shear web 14 comprises a web panel 30 arranged between upper and lower flanges 32, 34. The flanges 32, 34 are substantially T-shaped, comprising a base 36 and an upstand 38. The upstands 38 of the flanges 32, 34 are integrated with the shear web panel 30 in a lamination process and the shear web 14 accordingly comprises a composite structure wherein the web panel 30 and flanges 32, 34 are sandwiched between two outer laminate layers 40. The flanges 32, 34 of the shear web 14 are bonded to a surface 42, 44 of the blade shell 16 by a layer of adhesive 46.

The T-shaped profile of the flanges 32, 34 and their orientation are consistent along the length of the shear web 14, as can be seen in a comparison of FIGS. 1b and 1c. Similarly, the orientation of the shear web panel 30 is consistent along the length of the blade 12 due to its rigid planar form. The configuration of each flange 32, 34 is optimised in the first spanwise section 26 (as shown in FIG. 1b) such that a uniform adhesive bondline thickness T1 is achieved between the base 36 of each flange 32, 34 and the blade shell surface 42, 44 to which it is bonded. However, the configuration of each flange 32, 34 is not optimised for bonding in the second spanwise section 28 due to the twist of the blade 12 and the variation in airfoil geometry.

The adhesive bondline 46 between the flanges 32, 34 and the blade shell surface 42, 44 in the second spanwise section 28 (as shown in FIG. 1c) varies in thickness T2 across the chordwise (C) width of each flange 32, 34. Additional adhesive 46 is required in the bondline to fill the space between the base 36 of each flange 32, 34 and the blade shell surface 42, 44. This can result in unfavourable structural characteristics as the adhesive bondline thickness T between the shear web 14 and the blade shell surface 42, 44 is inconsistent along the length of the shear web 14, and also results in increased adhesive use, increasing the weight of the blade 12.

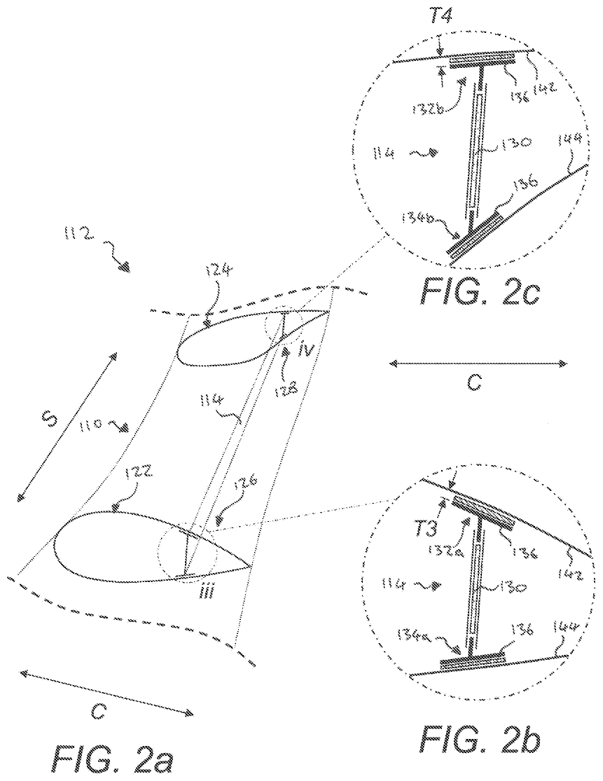

FIG. 2a is a schematic perspective view of a spanwise portion 110 of a wind turbine blade 112 comprising a shear web 114 according to a further example of the prior art, with FIGS. 2b and 2c showing detailed views of transverse cross sections 122, 124 in first and second spanwise sections 126, 128 respectively. Contrary to the prior art example described with reference to FIGS. 1a to 1c, the adhesive bondline thickness T between the shear web 114 and the blade shell surface 142, 144 is consistent along the length of the shear web 114 in the present example. A comparison of FIGS. 2b and 2c shows that the bondline thickness T3, T4 is substantially uniform throughout both the first and second spanwise sections 126, 128 of the shear web 114.

However, the T-shaped profile of the flanges 132, 134 and their orientation are not consistent along the length of the shear web 114. The configuration of each flange 132, 134 is optimised in both the first and second spanwise sections 126, 128 of the shear web 114 such that a uniform adhesive bondline thickness T3, T4 is achieved between the base 136 of each flange 132, 134 and the blade shell surface 142, 144 to which they are bonded. Whilst it is desirable to achieve a substantially uniform bondline thickness T along the length of the shear web 114, a number of different flange profiles 132a, 132b, 134a, 134b must be provided in order to match the inclination of the blade shell surface 142, 144 with respect to the shear web panel 130 in different spanwise (S) locations. A wind turbine blade shear web 114 according to such a prior art example is therefore relatively expensive, requiring a large number of unique flange sections 132a, 132b, 134a, 134b having different geometries along the length of the shear web 114.

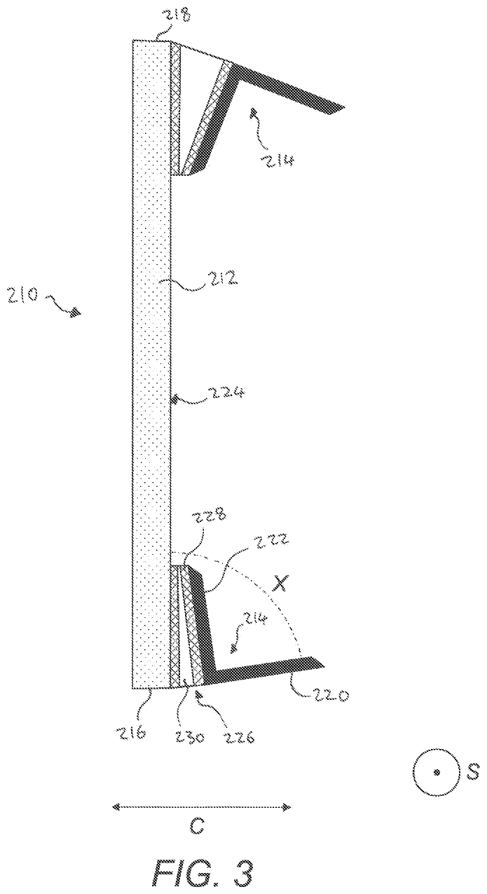

FIG. 3 is a schematic view showing an example of a wind turbine blade shear web 210 in a transverse cross section. The shear web 210 comprises an elongate web panel 212 which extends in a spanwise direction (S), perpendicular to the plane of the page in FIG. 3.

The shear web 210 comprises a mounting flange 214 extending along a longitudinal edge 216 of the panel 212. In this example, the shear web 210 comprises mounting flanges 214 extending along both longitudinal edges 216, 218 of the web panel 212. It will be understood that features in this example and the relations between these are substantially identical at both longitudinal edges 216, 218 of the web panel 212, and the description will be provided in reference to the lower longitudinal edge 216 in the configuration depicted in FIG. 3.

The mounting flange 214 comprises a base 220 and an upstand 222 extending transversely to the base 220. In this example, the mounting flange 214 is substantially L-shaped in transverse cross section. The mounting flange base 220 is bonded to a surface of a wind turbine blade shell in an assembled blade. The upstand 222 of the mounting flange 214 is adhesively bonded to a side surface 224 of the shear web panel 212.

The upstand 222 of the mounting flange 214 is inclined relative to the side surface 224 such that a bond gap 226 is defined between the upstand 222 and the side surface 224. The bond gap 226 is at least partially filled with adhesive 228 in order to bond the mounting flange upstand 222 to the shear web panel 212. As shown in FIG. 3, the bond gap 226 is substantially triangular when viewed in a transverse cross section due to the inclined relation of the mounting flange upstand 222 with the side surface 224.

The shear web 210 further comprises one or more spacers 230 located in the bond gap 226 between the mounting flange upstand 222 and the shear web panel 212. The spacers 230 are configured to set an angle of inclination X between the panel 212 and the base 220 of the mounting flange 214. In this example, the spacers 230 are shaped as wedges which are substantially triangular in transverse cross section. In this example, the mounting flange 214 is substantially rigid and the dimensions of the one or more spacers 230 therefore correspond directly to the orientation of the mounting flange 214, thereby setting the angle of inclination X between the panel 212 and the base 220 of the mounting flange 214.

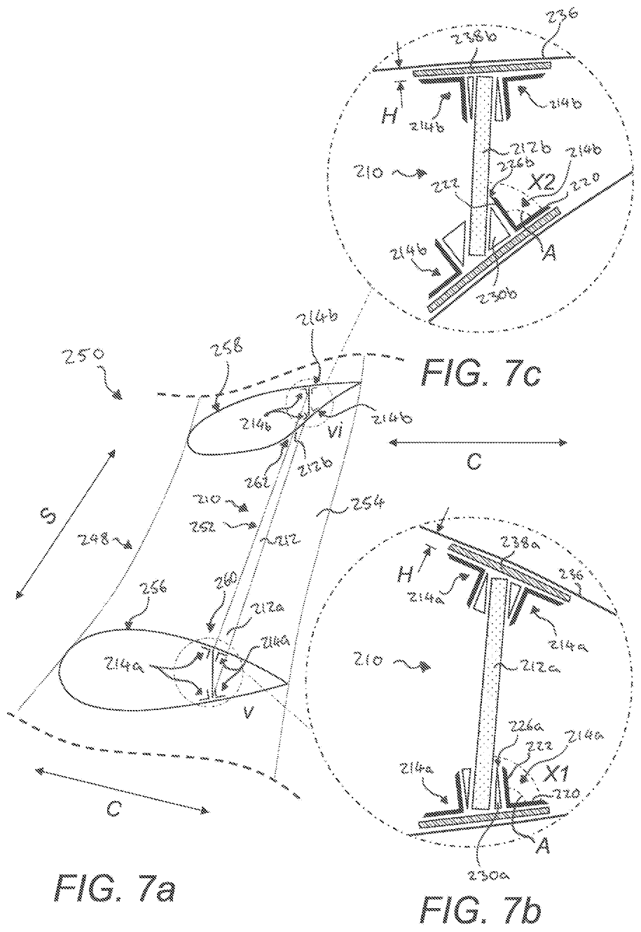

As will be described in further detail below with reference to FIGS. 7a to 7c, the angle of inclination X between the panel 212 and the mounting flange base 220 varies along the length of the shear web 210. Spacers 230 having different sizes or shapes are therefore implemented in different spanwise (S) sections along the length of a blade such that the angle of inclination X between the panel 212 and the base 220 of the mounting flange 214 substantially matches an angle of inclination of a blade shell surface with respect to the panel 212 along the length of the shear web 210.

Each of the one or more spacers 230 located in the bond gap 226 has a discreet spanwise length. For example, the spacers 230 may have a spanwise length in the range of 10 mm to 100 mm. Where a plurality of spacers 230 are located in the bond gap 226 along the length of the shear web 210, the spacers 230 are distributed at spanwise intervals. For example, the spacers 230 may be located in the bond gap 226 at spanwise intervals in the range of 1 m to 2 m separation.

In some examples, a single spacer may have a spanwise length substantially similar to the length of the shear web, the single spacer thereby extending along the entire length of the shear web.

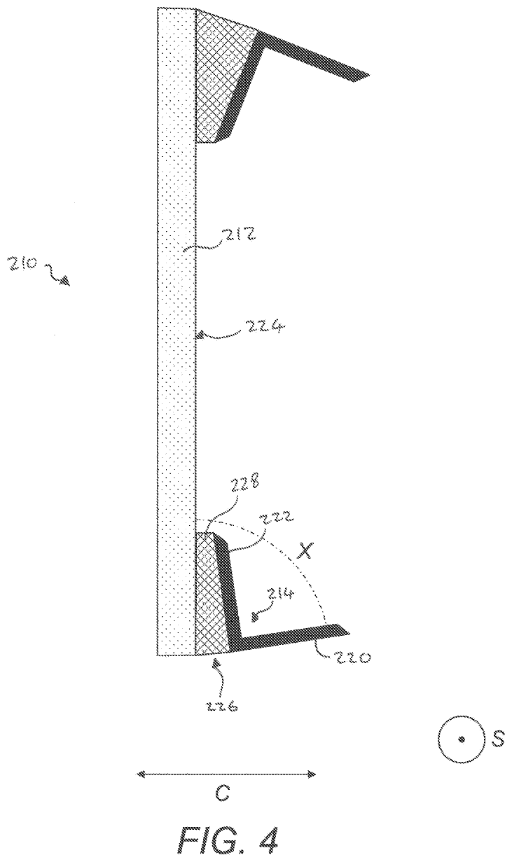

FIG. 4 is a transverse cross section of the wind turbine blade shear web 210 of FIG. 3 in a spanwise section in between spacers 230, i.e. where no spacer 230 is present in the bond gap 226. In such a spanwise section, the bond gap 226 is substantially or at least partially filled with adhesive 228 to bond the upstand 222 of the mounting flange 214 to the side surface 224 of the shear web panel 212. The upstand 222 of the mounting flange 214 is inclined relative to the side surface 224 of the shear web panel 212 as a result of the arrangement of one or more spacers 230 in the bond gap 226 in other spanwise sections along the length of the shear web 210.

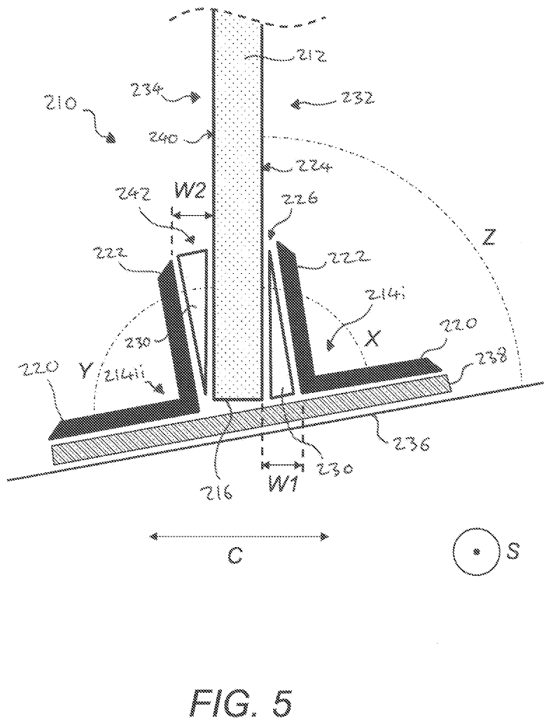

FIG. 5 is a schematic view of part of a wind turbine blade shear web 210 in accordance with another example shown in a transverse cross section. The shear web 210 in this example comprises a mounting flange 214i, hereafter referred to as a first mounting flange, on a first side 232 of the shear web 210 as described in reference to FIGS. 3 and 4. The shear web 210 comprises a further mounting flange 214ii, hereafter referred to as a second mounting flange, on a second side 234 of the shear web 210, which extends along the same longitudinal edge 216 of the panel 212 as the first mounting flange 214i. The second mounting flange 214ii comprises a base 220 and an upstand 222 extending transversely to the base 220. In this example, the respective bases 220 of each of the mounting flanges 214i, 214ii are substantially coplanar when viewed in a transverse cross section as shown in FIG. 5. The base 220 of each mounting flange 214i, 214ii is bonded to a surface 236 of a wind turbine blade shell by a layer of adhesive 238.

The upstand 222 of the second mounting flange 214ii is inclined relative to an opposite side surface 240 of the web panel 212, the opposite side surface 240 being defined as the surface of the shear web panel 212 opposite to the previously-described side surface 224. A further bond gap 242, hereafter referred to as a second bond gap, is defined on the second side 234 of the shear web 210 between the upstand 222 of the second mounting flange 214ii and the opposite side surface 240. The second bond gap 242 is at least partially filled with adhesive (not shown in FIG. 5 for clarity) in order to adhesively bond the upstand 222 of the second mounting flange 214ii to the opposite side surface 240 of the web panel 212. One or more spacers 230 are located in the second bond gap 242 and serve to set an angle of inclination Y between the base 220 of the second mounting flange 214ii and the shear web panel 212.

In the present example, the second bond gap 242 is substantially triangular when viewed in transverse cross section. As shown in FIG. 5, each of the bond gaps 226, 242 taper in width W1, W2 respectively, the width of a bond gap 226, 242 being defined as the distance in the chordwise direction (C) between the upstand 222 of a mounting flange 214i, 214ii and the respective side surface 224, 240 to which it is adhesively bonded. One of the bond gaps 226 or 242 tapers in an opposite sense to the other bond gap 242 or 226 when the shear web 210 is viewed in a transverse cross section. The opposite tapering of the bond gaps 226, 242 is resultant from the inclination X, Y of the base 220 of each mounting flange 214i, 214ii with respect to the shear web panel 212, said inclination of the bases 220 being configured to best match the inclination Z of the surface 236 of the wind turbine blade shell with respect to the shear web panel 212.

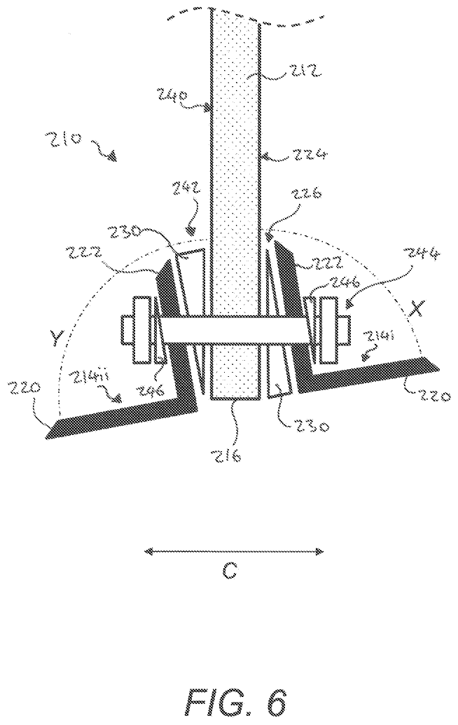

FIG. 6 is a schematic view in a transverse cross section showing a stage in the process of manufacturing a wind turbine blade shear web 210. An elongate web panel 212 is provided and may be supported in a vertical orientation as depicted in FIG. 6, or may alternatively be oriented horizontally.

A mounting flange 214i is provided and arranged to extend along a longitudinal edge 216 of the shear web panel 212. In the example shown in FIG. 6, a further mounting flange 214ii is arranged along the longitudinal edge 216 of the panel 212. One or more spacers 230 are provided, and these are arranged in the bond gaps 226, 242 defined between the upstand 222 of each mounting flange 214i, 214ii and a respective side surface 224, 240 of the shear web panel 212, setting the angle of inclination X, Y between the base 220 of each mounting flange 214i, 214ii and the shear web panel 212.

The upstand 222 of each mounting flange 214i, 214ii is adhesively bonded to a respective side surface 224, 240 of the shear web panel 212. Adhesive 228 (not shown in FIG. 6 for clarity) may be applied between the upstand 222 of a mounting flange 214i, 214ii and a respective side surface 224, 240 of the panel 212 either before arranging the one or more spacers 230, or after the arrangement of spacers 230. Preferably adhesive 228 is applied before the one or more spacers 230 are arranged. Conducting the manufacturing stages in this order can aid in a more thorough adhesion between the mounting flange 214i, 214ii and web panel 212 as the adhesive 228 is squeezed into any openings throughout the bond gap 226, 242 when arranging the one or more spacers 230.

In the example depicted in FIG. 6, a compression joint is formed to hold each mounting flange 214i, 214ii and the shear web panel 212 in fixed relation during manufacture of the shear web 210 prior to any adhesive 228 being cured. In this example, a nut and bolt configuration 244 is arranged through the mounting flange upstands 222 and shear web panel 212 in a substantially chordwise direction (C). Use of wedge shaped or tapering washers 246 ensures the compressive force is enacted on a surface perpendicular to the direction of the force and aids in the accurate alignment of shear web components.

It is anticipated that other means for holding a mounting flange 214 and shear web panel 212 in fixed relation during manufacture may be implemented in other examples, and the invention is not limited in this respect. For example, a U or G shaped clamp may be arranged below the mounting flange 214, with fixed and movable jaws of the clamp extending around the base 220 of the mounting flange 214 to interface with the flange upstand 222 and a side surface 224, 240 of the shear web panel 212. In such an example using a U or G shaped clamp, holes in the shear web components through which bolts may be arranged would not be required.

In some examples, the adhesive 228 (shown in FIG. 3) in the bond gaps 226, 242 is completely cured during the manufacture of the shear web 210. In other examples, the adhesive 228 may be part-cured during assembly of the shear web 210 before the shear web 210 is arranged with a wind turbine blade shell. In such an example, the adhesive 228 in the bond gap 226, 242 may be fully cured concurrently with the curing of the adhesive 238 (shown in FIG. 5) which bonds the shear web 210 to a surface 236 of the wind turbine blade shell.

FIG. 7a is a schematic perspective view showing a spanwise portion 248 of a wind turbine blade 250 comprising a spanwise portion 252 of a shear web 210. The wind turbine blade 250 comprises a blade shell 254 having a twisted profile designed to effectively capture energy from wind incident on the blade 250. Transverse cross sections 256, 258 in first and second spanwise sections 260, 262 of the shear web 210 are shown on FIG. 7a. A comparison of the cross sections 256 and 258 shows the varying airfoil profile throughout the spanwise portion 248 of the blade 250.

FIGS. 7b and 7c respectively show detailed views of the regions on FIG. 7a marked v and vi. Accordingly, FIG. 7b shows a schematic view of the shear web 210 in a transverse cross section in a first spanwise section 260 of the shear web 210, and FIG. 7c shows a schematic view of the shear web 210 in a transverse cross section in a second spanwise section 262 of the shear web 210.

In this example, each of the mounting flanges 214 comprise first and second spanwise flange sections 214a, 214b which are bonded respectively to first and second spanwise sections 212a, 212b of the shear web panel 212. The first and second spanwise flange sections 214a, 214b are substantially identical in transverse cross section as shown in FIGS. 7b and 7c. A shear web 210 as shown in this example therefore does not require unique flange sections having different transverse cross-sections in comparison to the prior art example of FIGS. 2a to 2c.

Each of the flange sections 214a, 214b comprises a base 220 and an upstand 222 extending transversely to the base 220. An angle A defined between the base 220 and the upstand 222 of the mounting flange 214, or base 220 and upstand 222 of each flange section 214a, 214b, is substantially constant throughout the spanwise portion 252 of the shear web 210. For example, as seen in a comparison of FIGS. 7b and 7c, the angle A between the base 220 and upstand 222 is substantially 90° for the first and second spanwise flange sections 214a, 214b.

Conversely, the angle of inclination X between the panel 212 and the base 220 of the mounting flange 214 varies throughout the spanwise portion 252 of the shear web 210 in order to accommodate the twisted profile of the blade shell 254. The base 220 of the first flange section 214a, in the first spanwise section 260 of the shear web 210, is inclined at a first angle X1 with respect to the shear web panel 212. The base 220 of the second flange section 214b, located in the second spanwise section 262 of the shear web 210, is inclined at a second angle X2 with respect to the shear web panel 212. The second angle of inclination X2 is different to the first angle X1 when comparing the orientation of a first spanwise flange section 214a to the orientation of a corresponding second spanwise flange section 214b.

Referring still to FIGS. 7b and 7c, the shear web 210 comprises a first spacer 230a arranged in the bond gap 226a between the first flange section 214a and the panel 212 in the first spanwise section 260 of the shear web 210. Similarly, in the second spanwise section 262 of the shear web 210, the shear web 210 comprises a second spacer 230b arranged in the bond gap 226b between the second flange section 214b and the panel 212. As shown in FIGS. 7b and 7c, the respective first spacer 230a has a different size and/or shape to the corresponding second spacer 230b located in the second spanwise section 262 of the shear web 210.

The thickness H of the adhesive bondline 238 between the shear web 210 and the blade shell surface 236 is substantially uniform along the length of the shear web 210. A comparison of the adhesive bondlines 238a, 238b in FIGS. 7b and 7c shows the consistency in bondline thickness H between the first spanwise section 260 of the shear web 210, in FIG. 7b, and the second spanwise section 262 of the shear web 210 in FIG. 7c. A bondline 238 of consistent thickness H along the length of the shear web 210 improves structural properties of the wind turbine blade 250 and enables more accurate structural modelling in designing the blade 250. Further, adhesive usage is reduced with a consistent bondline thickness in comparison to the prior art example of FIGS. 1a to 1c, resulting in a reduction in the weight of the wind turbine blade 250.

A shear web 210 in accordance with this example therefore comprises the advantages of each of the prior art shear webs described with reference to FIGS. 1a to 2c. Namely, the shear web 210 in this example enables a substantially uniform bondline thickness H between the shear web 210 and the blade shell surface 236 along the length of the shear web 210, without the requirement of multiple unique flange sections which each have different transverse cross-sections. A substantially uniform bondline thickness H may therefore be achieved whilst reducing the number of unique parts required for the shear web 210.

In a further example, the shear web 210 comprises a mounting flange 214 having a sufficient torsional flexibility that the flange 214 may twist along its spanwise length where spacers 230 of different shapes and/or sizes are located in the bond gap 226. A single flange section 214a, 214b may therefore twist along its spanwise length, defining a plurality of angles X between the shear web panel 212 and the base 220 of the mounting flange section 214a, 214b along the length of the section.

In other spanwise portions of the blade 250 (not shown), the angle A between the base 220 and the upstand 222 of spanwise adjacent flange sections 214a, 214b may be different, the flange sections being dissimilar in transverse cross section. The angle A between the base 220 and upstand 222 of a first flange section 214a may therefore be different to the angle A between the base 220 and upstand 222 of a second flange section 214b.

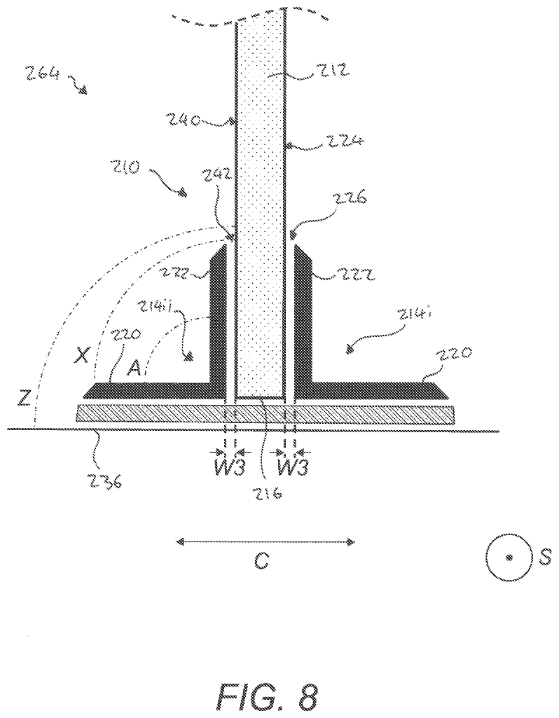

FIG. 8 shows a schematic view of a further portion 264 of a shear web 210 of a wind turbine blade 250 in a transverse cross section. In some spanwise portions of the wind turbine blade 250 it is anticipated that the upstand 222 of each mounting flange 214i, 214ii may be arranged substantially parallel to a respective side surface 224, 240 of the shear web panel 212 and that one or more spacers 230 are therefore not required in a bond gap 226, 242 to set an angle of inclination X of the mounting flange base 220. As shown in FIG. 8, in such spanwise portions 264, the bond gaps 226, 242 are a substantially uniform width W3 throughout, and the upstand 222 of a mounting flange 214 is not inclined relative to the shear web panel 212. In such a spanwise portion 264, the shear web 210 may simply comprise an elongate panel 212 and one or more mounting flanges 214 extending along a longitudinal edge 216 of the panel 212.

In an example, the mounting flanges 214 may extend along the entire length of the shear web 210, or may alternatively extend in discrete spanwise (S) lengths 214a, 214b. For example, such mounting flange sections 214a, 214b may extend in 1 m lengths and may be spaced along the length of the shear web 210 at regular or irregular spanwise intervals.

The mounting flange(s) 214 are adhesively bonded to side surfaces 224, 240 of the shear web panel 212. In this example, the shear web 210 comprises a mounting flange 214 bonded to each side surface 224, 240 of the shear web panel 212. It is also anticipated that in some spanwise portions of the blade 250, the shear web 210 may only comprise a mounting flange 214 adhesively bonded to one of the side surfaces 224 or 240 of the panel 212.

A spanwise portion 264 of the blade 250 as shown in FIG. 8, wherein the upstand 222 of a mounting flange 214 is substantially parallel to the shear web panel 212, may be considered a datum point in the blade 250. A deviation in the relative angle Z between the blade shell surface 236 and the shear web panel 212 from such a datum point along the length of the shear web 210 could require the use of a spacer 230 as described throughout in order to set the angle X of the mounting flange base 220 with respect to the web panel 212 for a given spanwise portion to match the inclination angle Z of the blade shell surface 236 with respect to the web panel 212.

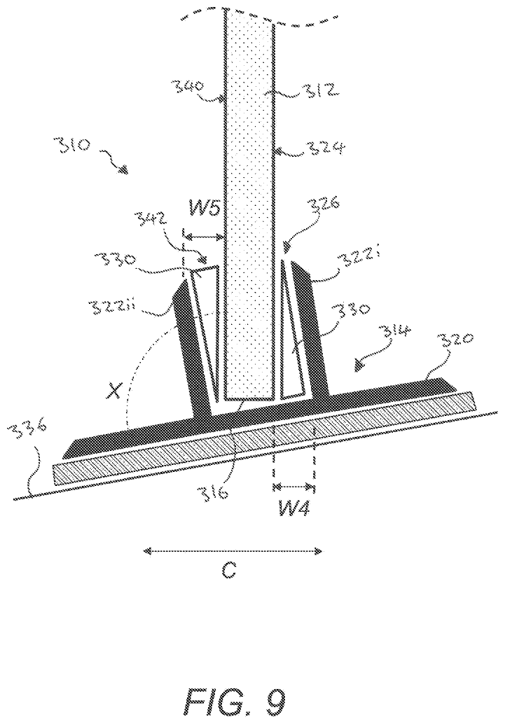

FIG. 9 is a schematic view of a further example shown in a transverse cross section. In this example, the shear web 310 comprises a mounting flange 314 having an upstand 322i a further upstand 322ii, hereafter referred to as a second upstand, which extends transversely to the base 320. The mounting flange 314 is therefore substantially pi-shaped (π) in transverse cross section and the longitudinal edge 316 of the shear web panel 312 is received between the upstands 322. A bond gap 326 is defined between the upstand 322i and side surface 324, and a further, second, bond gap 342 is defined between the second upstand 322ii and opposite side surface 340 of the panel 312.

In a similar manner to the example described with reference to FIG. 5, each of the bond gaps 326, 342 are substantially triangular when viewed in a transverse cross section and taper in chordwise width W4, W5. The bond gaps 326, 342 taper in an opposite sense to one another as a result of the inclination X of the mounting flange base 320 in relation to the shear web panel 312.

The bond gaps 326, 342 are at least partially filled with adhesive (not shown) which bonds each upstand 322i, 322ii to a respective side surface 324, 340 of the shear web panel 312. One or more spacers 330, as previously described, are located in each of the bond gaps 326, 342 to set an angle of inclination X between the shear web panel 312 and the base 320 of the mounting flange 314. As described with reference to FIGS. 7a to 7c, spacers 330 arranged in different spanwise sections of the shear web 310 may have a different size and/or shape such that the angle X between the web panel 312 and the mounting flange base 320 varies along the length of the shear web 310 to match the twisted profile of a wind turbine blade shell.

Further, as described with reference to the L-shaped mounting flanges 214 in FIGS. 7a to 7c, the pi-shaped mounting flange 314 of this example may comprise first and second spanwise flange sections which are bonded respectively to first and second spanwise sections of the shear web panel 312. The angle of inclination X between the base 320 of a first mounting flange section and the shear web panel 312 may be different to the angle of inclination X between the base 320 of a second mounting flange section and the shear web panel 312.

In a similar manner to the example shown in FIG. 8, in some spanwise portions of the blade, a spacer 320 may not be required in the bond gaps 326, 342 between the upstands 322i, 322ii of a pi-shaped mounting flange 314 and the shear web panel 312. In such a spanwise portion, the upstands 322i, 322ii of the pi-shaped flange 314 are arranged substantially parallel to the respective side surfaces 324, 340 of the shear web panel 312 to which they are adhesively bonded.

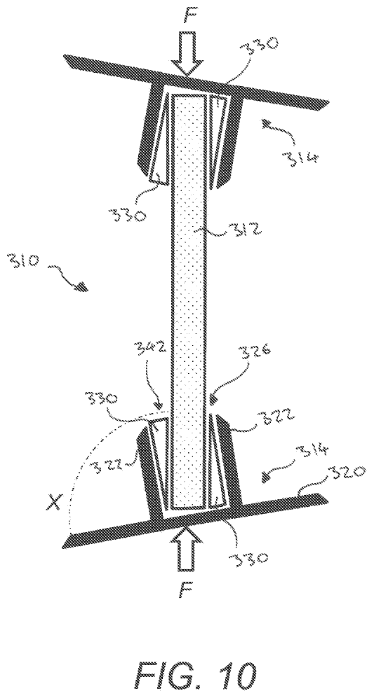

FIG. 10 schematically shows an arrangement of pi-shaped (π) mounting flanges 314 with a shear web panel 312 in a transverse cross-sectional view. In the assembly of a shear web 310 comprising pi-shaped mounting flanges 314, the process may be simplified in comparison to the method for manufacturing a shear web 210 comprising L-shaped mounting flanges 214 as described with reference to FIG. 6.

When assembling a shear web 310 comprising a mounting flange 314 having two upstands 322, there is a reduced requirement for fixtures or compression joints to correctly align components. Adhesive (not shown in FIG. 10) is applied and one or more spacers 330 are arranged in each bond gap 326, 342 between the upstands 322 and the web panel 312, the adhesive at least partially filling the bond gaps 326, 342. The geometry of the spacers 330 and their arrangement with upstands 322 of the mounting flanges 314 serve to self-locate each mounting flange 314 in the desired orientation with respect to the shear web panel 312 through the application of a force in a direction substantially parallel to the shear web panel 312, indicated by arrows F on FIG. 10. The required angle X between the mounting flange base 320 and the shear web panel 312 can therefore be achieved in a simple manufacturing process. As with the example described with reference to FIG. 6, adhesive in the bond gaps 326, 342 may be cured during the manufacture of the shear web 310. Alternatively, the adhesive may be part-cured prior to being completely cured concurrently with the curing of adhesive bonding the shear web 310 to wind turbine blade surface 336.

The examples described above provide a shear web for a wind turbine blade having a number of advantages over shear webs of the prior art. A shear web as described above may comprise fewer unique components, for example by implementing flange sections having a substantially identical transverse cross section, thereby increasing part commonality and reducing the cost of producing a wind turbine blade. Further, with shear webs as described in the examples above, a substantially uniform adhesive bondline thickness between the shear web and a surface of the wind turbine blade shell may be achieved without requiring a large number of unique flange sections.

The angle of inclination of the base of each mounting flange with respect to the shear web panel is more accurately matched to the angle of inclination of the blade shell surface with respect to the shear web panel throughout the shear web than with shear webs of the prior art. The load bearing capacity of the blade is thereby increased, and the substantially uniform bondline thickness enables more accurate structural modelling of the blade in the design phase. Further, adhesive usage, and thereby also weight of a blade comprising a shear web as described above, is reduced as a result of the substantially uniform bondline thickness along the length of the shear web despite the twisted profile of the blade.

The methods for manufacturing shear webs as described above also present advantages over prior art methods of manufacturing shear webs. In the methods described above, a shear web may be produced in a simpler manufacturing method than those of the prior art. In prior art methods for producing wind turbine blade shear webs, such as lamination or Vacuum Assisted Resin Transfer Moulding (VARTM), complex and often expensive tooling may be required to accurately manufacture a shear web to the design specification. No such tooling is required in manufacturing a shear web accordance with the examples provided above. Further, ancillary equipment such as vacuum pumps or infusion systems are not required in the present method.

Flexibility in the orientation of the shear web panel in the manufacture of a shear web according to the above described methods provides a benefit over prior art manufacturing methods. A vertically oriented shear web panel has a smaller footprint than a horizontally oriented panel, enabling more efficient use of floor space in a manufacturing facility. The methods may be used for a variety of different shear web designs for use in different wind turbine blade models, and separate tooling is not required to produce different shear web designs; further increasing efficiency of floor space usage. Shear webs for many different blade designs may therefore be produced in a single manufacturing facility.

Many modifications may be made to the examples described above without departing from the scope of the present invention as defined in the accompanying claims.

For example, although mounting flanges having an upstand extending substantially perpendicular to their base are depicted throughout the figures in relating to the examples described above, it is also anticipated that mounting flanges having angles other than 90° between the base and upstand may be adhesively bonded to a side surface of the panel. Such mounting flanges or flange sections may be implemented in spanwise portions where a spacer is required to set the angle of inclination of the base, and also in spanwise portions without a spacer in the bond gap. Similarly, mounting flanges, or mounting flange sections, having a range of different angles between their respective bases and upstands may be implemented along the shear web.

1. A wind turbine blade shear web comprising an elongate web panel and a mounting flange extending along a longitudinal edge of the panel, the mounting flange comprising a base for bonding the shear web to a surface of a wind turbine blade shell and an upstand extending transversely to the base,
the upstand being adhesively bonded to a side surface of the web panel and inclined relative to the side surface such that a bond gap is defined between the upstand and the side surface,
wherein the bond gap is at least partially filled with adhesive and one or more spacers are located in the bond gap, wherein the one or more spacers are configured to set an angle of inclination between the panel and the base of the mounting flange.

2. The wind turbine blade shear web of claim 1, wherein the bond gap is substantially triangular when viewed in transverse cross section.

3. The wind turbine blade shear web of claim 1, wherein the one or more spacers are substantially triangular in transverse cross section.

4. The wind turbine blade shear web of claim 1, wherein the one or more spacers are shaped as wedges.

5. The wind turbine blade shear web of claim 1, wherein the angle of inclination between the panel and the base of the mounting flange varies in a spanwise portion of the shear web, and wherein an angle between the base and the upstand of the mounting flange is substantially constant throughout the spanwise portion.

6. The wind turbine blade shear web of claim 1, wherein the mounting flange comprises first and second spanwise flange sections bonded respectively to first and second spanwise sections of the panel, the first and second flange sections being substantially identical in transverse cross section, wherein the base of the first flange section is inclined at a first angle to the panel and the base of the second flange section is inclined at a second angle to the panel, the second angle being different to the first angle, and wherein a first spacer is arranged in the bond gap between the first flange section and the panel, and a second spacer is arranged in the bond gap between the second flange section and the panel, wherein the first spacer has a different size and/or shape to the second spacer.

7. The wind turbine blade shear web of claim 1, wherein the mounting flange is substantially L-shaped in transverse cross section.

8. The wind turbine blade shear web of claim 1, wherein the mounting flange comprises a further upstand extending transversely to the base, and the longitudinal edge of the panel is received between the upstands such that a further bond gap is defined between the further upstand and an opposite side surface of the shear web panel, wherein the further bond gap is at least partially filled with adhesive and one or more spacers are located in the further bond gap.

9. The wind turbine blade shear web of claim 8, wherein the mounting flange is substantially pi-shaped in transverse cross section.

10. The wind turbine blade shear web of claim 1, wherein the shear web comprises a further mounting flange extending along the longitudinal edge of the panel, said further mounting flange comprising a base and an upstand extending transversely to said base, said upstand being adhesively bonded to an opposite side surface of the web panel and inclined relative to the opposite side surface such that a further bond gap is defined between said upstand and the opposite side surface, wherein the further bond gap is at least partially filled with adhesive and one or more spacers are located in the further bond gap.

11. The wind turbine blade shear web of claim 10, wherein the respective bases of the two mounting flanges are substantially coplanar when the shear web is viewed in transverse cross section.

12. The wind turbine blade shear web of claim 8, wherein both bond gaps taper in width and one of the bond gaps tapers in an opposite sense to the other bond gap when the shear web is viewed in transverse cross section.

13. A wind turbine blade comprising the shear web of claim 1.

14. The wind turbine blade of claim 13, wherein the blade shell has a twisted profile and wherein the angle of inclination between the panel and the base of the mounting flange varies along the length of the shear web to accommodate the twisted profile of the blade shell.

15. A method of making a wind turbine blade shear web, the method comprising;
providing an elongate web panel;
providing a mounting flange having a base and an upstand extending transversely to the base;
providing one or more spacers;
setting an angle of inclination between the panel and the base of the mounting flange by arranging the one or more spacers between the upstand and a side surface of the panel; and
bonding the upstand to the side surface of the panel.
